(19) United States
(12) Patent Application Publication
(10) Pub. No.: US 2024/0077323 A1
(43) Pub. Date: Mar. 7, 2024

(54) ARTIFICIAL INTELLIGENCE-BASED ROUTE RECOMMENDATIONS BASED ON ADVERTISING

(71) Applicant: International Business Machines Corporation, Armonk, NY (US)

(72) Inventors: Reji Jose, Bangalore (IN); Manoj Kumar Goyal, Bangalore (IN); Raghuveer Prasad Nagar, Kota (IN); Sajan Kashyap S, Bangalore (IN)

(21) Appl. No.: 17/929,335

(22) Filed: Sep. 2, 2022

(51) Int. Cl. G01C 21/34; G06Q 30/02

(52) U.S. Cl. CPC G01C 21/3476; G01C 21/3484; G06Q 30/0241

(57) ABSTRACT

Recommending commute options to a user based on a relevance of physical advertisements on the commute options to user's requirements includes capturing, by a computer, physical advertisements on possible commute options within a region, determining an item requirement of a user and correlating the captured physical advertisements on each possible commute option with the determined item requirement of the user, and determining a user's availability to look at the physical advertisements on each possible commute option between a starting point of a trip and a final point of the trip. A relevance score is then assigned to each of the captured physical advertisements on each possible commute option and the determined item requirement of the user, and based on the relevance score and the determined user's availability to look at the physical advertisements for each possible commute option, all possible commute options are sorted and communicated to a user device.

### BACKGROUND

The present invention generally relates to the field of cognitive-based commerce solutions, and more particularly to an artificial intelligence (AI) based system for generating commuting or travel routes based on a relevance of available advertising.

Currently, most people rely upon commercial web mapping platforms or route planner apps for daily commute options. Route planners are available today in transport vehicles as well as on the web and smart devices, where users can choose from any of a number of route planners (e.g., Google maps, Apple maps, MapQuest, etc.). Although these planners are increasingly reliable in their knowledge, they all share the same static-world assumptions. In particular, they are all built around the assumptions of constancy and universality, for example, that an optimal route can be independent of the time and day of the actual journey and of the individual preferences and needs of the users.

### SUMMARY

Shortcomings of the prior art are overcome and additional advantages are provided through the provision of a computer-implemented method for recommending commute options based on advertisement relevance. The method includes capturing, by one or more processors, physical advertisements on possible commute options within a region, determining an item requirement of a user and correlating the captured physical advertisements on each possible commute option with the determined item requirement of the user, determining a user's availability to look at the physical advertisements on each possible commute option between a starting point of a trip and a final point of the trip, assigning a relevance score to each of the captured physical advertisements on each possible commute option and the determined item requirement of the user, and based on the relevance score and the determined user's availability to look at the physical advertisements for each possible commute option, sorting all possible commute options and communicating the sorted commute options to a user device.

Another embodiment of the present disclosure provides a computer system for recommending commute options based on advertisement relevance, based on the method described above.

Another embodiment of the present disclosure provides a computer program product for recommending commute options based on advertisement relevance, based on the method described above.

### BRIEF DESCRIPTION OF THE DRAWINGS

The following detailed description, given by way of example and not intended to limit the invention solely thereto, will best be appreciated in conjunction with the accompanying drawings, in which:

FIG. 1 is a block diagram illustrating a networked computer environment, according to an embodiment of the present disclosure;

FIG. 2 depicts a computer system for generating a commute recommendation based on a relevance of physical advertising, according to an embodiment of the present disclosure;

FIG. 3A depicts a flowchart illustrating the steps of a computer-implemented method for generating a commute recommendation based on a relevance of physical advertising, according to an embodiment of the present disclosure; and

FIG. 3B is a continuation of the flowchart of FIG. 3A, according to an embodiment of the present disclosure

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Different modes of transportation are available to users for traveling to a particular destination. As mentioned above, mapping platforms or route planner apps are available today in most transport vehicles as well as on the web and smart devices, where users can choose from any of a number of route planners (e.g., Google maps, Apple maps, MapQuest, etc.). Based on the selected mode of transportation, different route options may be presented to the user(s) by the route planner program. Disadvantageously, most route planner programs are built around the assumptions of constancy and universality, i.e., that an optimal route is independent of the time and day of the actual journey and of the individual preferences and needs of the users. For example, a user may need to perform different activities while traveling between different points (e.g., dropping a parcel, grocery shopping, etc.) and the generated optimal route ignores such preferences. By ignoring users' needs or requirements to create a traveling route, commercial advertisement of potential interest to the users (i.e., related to users' individual needs) can be missed by the route planner.

The following described exemplary embodiments provide an artificial intelligence (AI)-based method, system, and computer program product to, among other things, automatically generate commute options based on a relevance of physical advertisement available on the commute options to user's requirements or needs. Stated differently, possible commute options are generated and presented to the user based on the likelihood of the physical advertisement (e.g., billboard ads, advertising signs, etc.) existing in each possible commute option matching a determined need or requirement of the user.

Thus, the present embodiments have the capacity to improve the technical field of cognitive-based commerce solutions by automatically generating possible commute options based on a correlation between user's requirements and a relevance of the available physical advertisement on the possible commute options to meet the user's requirement. According to an embodiment, available physical advertisement (e.g., advertising ads on a roadside or public vehicle) on the commute options can be capture from one or more of the following data sources: IoT data (e.g., cameras installed in public transportation vehicles), saved advertisement information in local systems, and the like. Similarly, user's requirements/preferences can be derived based on one or more of the following data sources: a purchase history, social media sites, IoT data, interaction with customer service centers, etc. Additionally, the proposed embodiments can recommend commute options based on an identified urgency of the user to reach a certain destination or to meet a certain need. Such identification can be performed based on one or more of a type of destination provided by the user to the route planner application (e.g., a hospital, a store or business about to close, etc.), a calendar entry (e.g., suggesting that the user has enough time to travel on a certain route), IoT data (e.g., from wearable devices), etc. Accordingly, the proposed embodiments can improve future commute option recommendations responsive to actions performed by the user and explicit user's feedback on the presented commute options based on the relevance of physical advertisement.

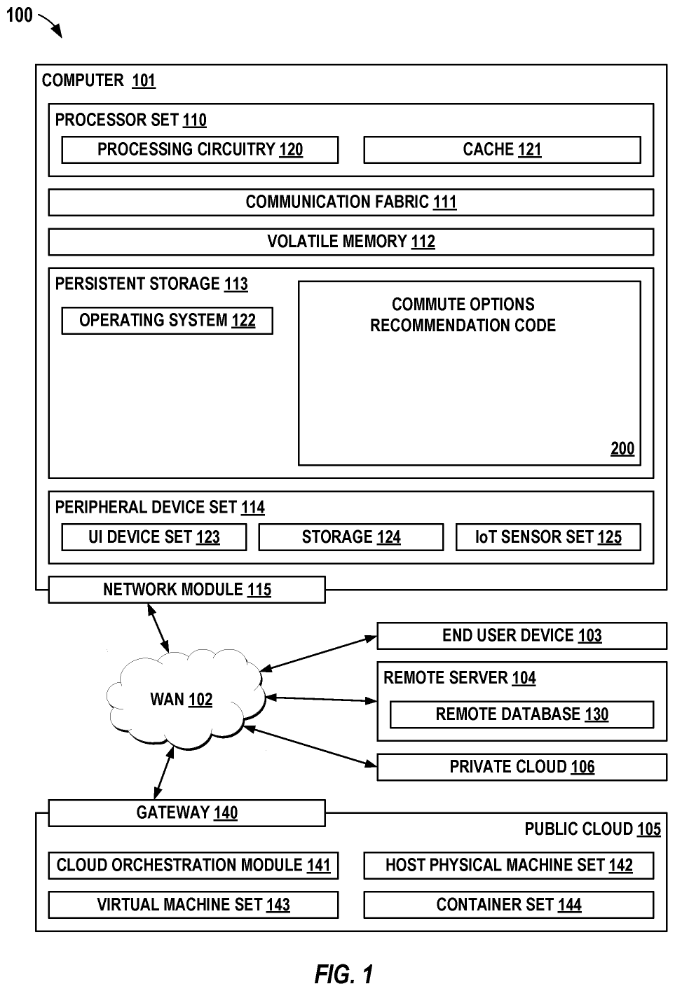

Referring now to FIG. 1, an exemplary computing environment 100 is depicted, according to an embodiment of the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as the commute options recommendation based on a relevance of physical advertisement code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

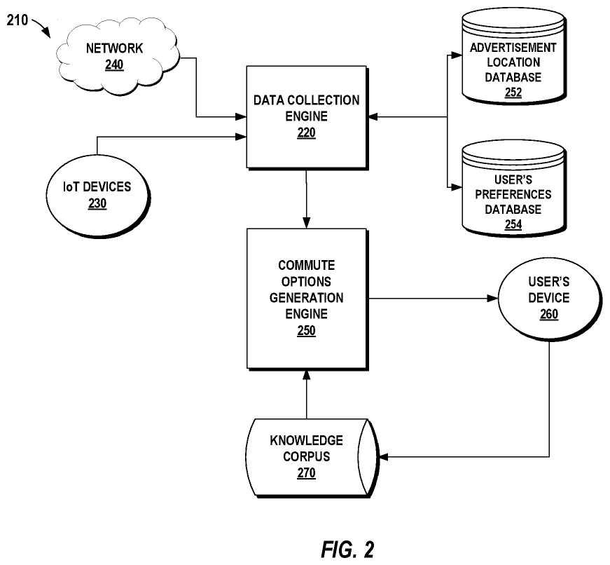

Referring now to FIG. 2, components of a computer system 210 for automatically recommending possible commute options to a user based on a relevance of physical advertisement on the commute options are shown, according to an embodiment of the present disclosure.

The computer system 210 may include a data collection engine 220, a commute options generation engine 250, user's device 260 and knowledge corpus 270. In an exemplary embodiment, the data collection engine 220 is communicatively connected to a plurality of IoT sensors or IoT devices 230 and a network 240 for collecting relevant information associated with the user and available commercial advertisement within a region. According to an embodiment, the commute options generation engine 250 identifies one or more possible traveling routes for a user of the computer system 210 using, for example, the commute options recommendation based on a relevance of physical advertisement code 200 shown in FIG. 1. The commute options generation engine 250, that is communicatively connected to user's device 260, sends or transmits the generated one or more traveling routes to the user via the user's device 260. In an embodiment, each recommended traveling route generated by the commute options generation engine 250 and transmitted to the user's device 260 is stored in a knowledge corpus 270 for future use by the commute options generation engine 250.

It should be noted that data collection (e.g., from IoT devices, advertisement databases, etc.) is done with user's consent via, for example, an opt-in and opt-out feature. The user can choose to stop having his/her information being collected or used. In some embodiments, the user can be notified each time data is being collected. The collected data is envisioned to be secured and not shared with anyone without previous consent. The user can stop data collection at any time.

According to an embodiment, the data collection engine 220 collects information corresponding to advertisement location within a region. In an exemplary embodiment, the data collection engine 220 stores the collected information in an advertisement location database 252 that can be overlaid on the road map of the region to show the exact location of each of the physical advertisements. In one or more embodiments, the data collection engine 220 retrieves advertisement location data from, for example, cameras available on public vehicles that serve as an IoT feed for recognizing advertisements in a particular route. For instance, images from video cameras located on a subway train or on the dashboard of a bus can be analyzed to identify the exact geographic location of billboards and roadside advertisements on a particular route. It should be noted that the computer system 210 may allow advertising entities (e.g., individuals or companies) to sign up for collaborating to keep the advertisement location database 252 up-to-date on the location of commercial advertisements in different routes. Although embodiments of the present disclosure refer to physical advertisement (e.g., ad billboards) available in one or more travel routes, other types of advertisement (e.g., digital) may also be considered.

Alternatively or additionally, the data collection engine 220 can also use images shared by social media users to locate advertisements. For example, if a person takes a selfie on a busy street and shares the picture on a social media website on a particular day, the data collection engine 220 can identify the exact location and time based on the picture metadata. The image can then be analyzed by the data collection engine 220 to identify whether there are any advertisements that are visible in the photograph. In one or more embodiments, data collection engine 220 may apply deep learning techniques such as R-CNN to detect advertisements in captured visuals.

With continued reference to FIG. 2, the data collection engine 220 may further collect data associated with user's needs or preferences. To understand the user's need, the data collection engine 220 analyzes the collected information and based on the analysis, derives the user's requirements or preferences for one or more of a product, a product category, a service, etc.

In an embodiment, prior user's consent, the data collection engine 220 may retrieve and analyze information from one or more of a calendar, an event planner, reminder settings, and the like to determine whether there are any major upcoming events in the user's life. For example, if the user has an upcoming wedding anniversary or if the user has set a reminder for their spouse's birthday. This may alert the computer system 210 that the user may want to purchase a gift for the event. Further, the collection engine 220 may also analyze the user's purchase history from previous years to determine whether gifts were purchased for the event. Based on the collected information, the user's need for buying a gift for the occasion is established by the computer system 210.

In an exemplary embodiment, the data collection engine 220 may analyze the user's purchase history to obtain further information regarding user's needs. For example, based on the collected user's purchase history data, the data collection engine 220 may identify that the user's vehicle insurance is about to expire, this helps establishing a need for the user to renew the current insurance policy or to buy a new insurance policy with a new insurance company.

In one or more embodiments, the data collection engine 220 may analyze user's social media or search activity to determine user's needs and preferences. For example, the data collection engine 220 may determine that the user has been searching for watches (e.g., via search engines, personal assistants, shopping catalogs, etc.) or has been viewing or reading customer reviews associated with a certain watch model. Based on this information, the computer system 210 derives or infers that the user may desire to purchase a watch.

Accordingly, the data collection engine 220 creates a list of user's needs that may be stored, for example, in a user's preferences database 254. In an embodiment, the data collection engine 220 may organize the list of user's needs according to a priority to satisfy or fulfil such requirements.

Additionally, the data collection engine 220, using collected data associated with the user, may determine a user's urgency or lack thereof to perform a trip. For example, the data collection engine 220 may derive an urgency of the user to travel to a certain destination. The data collection engine 220 may also determine whether the user is traveling for an emergency and there is no time to offer a route option including commercial advertisements. Thus, in such cases, the commute options generation engine 250 prioritizes the user's urgency to reach a destination over the display of targeted advertisements on the route. In such situations, the commute options generation engine 250 provides the user with an optimum route that minimizes advertisement display to get to the destination on time. According to an embodiment, the user's urgency can be determined by, for example, a type of destination the user is travelling to (e.g., hospital, to board a plane, to a store which closes very soon, etc.), a user's calendar showing that the user has an appointment, or a deviation from normal values on biometric parameters being measured by user's wearable devices (e.g., the user is sweating, has an elevated heart rate, etc.).

In some cases, the commute options generation engine 250 may determine the urgency of a trip from messages exchanged by the user before traveling. For example, the user may use words associated with urgency such as “late”, “fast”, “urgent”, etc. The commute options generation engine 250 uses this information to generate a route option based on the urgency of the trip (e.g., fastest trajectory, least amount of advertisements, etc.). This can be further refined using machine learning algorithms and historic data. NLP driven bagging techniques, including decision tree and SVM, can be used for the classification/bagging of the user's needs.

According to all the collected information, the commute options generation engine 250 generates one or more possible commute or route options. Each generated commute option takes into account an urgency of the user to get to a final destination, i.e., whether the user is travelling to the destination with or without any urgency and have enough time to be presented with advertisements during the trajectory of the trip. In cases in which it is determined that the user has enough time, the commute options generation engine 250 optimizes the route for presenting advertisements to the user that matches the determined user's needs. As depicted in FIG. 2, the commute options generation engine 250 is communicatively connected to the data collection engine 220, and thus to the user's preferences database 254 for constantly exchanging information regarding user's needs, preferences, or requirements that is used to generate commute options tailored to real-time user's needs.

In one or more embodiments, the commute options generation engine 250 first determines, based on information from the data collection engine 220, which products or services are of interest to the user. Then, the commute options generation engine 250 generates the one or more possible commute options that the user can take to reach a particular destination based on the availability of the user to be presented with the physical advertisement matching the user's needs.

In an embodiment, the commute options generation engine 250 selects an optimum route based on a predefined criteria including at least one of a travel time or a traveling distance. For example, assuming the predefined criteria for determining an optimal route includes a traveling distance of approximately 10 kilometers, the commute options generation engine 250 configures a variation threshold of ±x % of the selected predefined criteria. Then, the commute options generation engine 250 identifies all possible route options with a variation in distance within the range of ±x %. For example, if x is set to ±20%, the commute options generation engine 250 identifies all routes between the user's location and the destination that is between 8 kilometers and 12 kilometers.

In some embodiments, the variation threshold can be updated automatically. Referring to the example above, the percentage x can be configured based on the user's history or based on the distance. For instance, if the user is travelling 200 kilometers, a distance of 400 kilometers (x=20%) may not be a feasible distance for the user to travel. In such situation, the predefined criteria and variation threshold can be automatically replaced for a smaller percentage or distance variation.

The commute options generation engine 250 then matches the top n needs of the user with the available advertisements in all the identified routes. Stated differently, the user's needs are correlated with the captured physical advertisements on each available commute option. In one or more embodiments, the relevance of the physical advertisements on each available commute option is determined based on a correlation score for the physical advertising matching the user's need. The commute options generation engine 250 may then take into account the user's convenience or availability to look at the physical advertisements for each possible commute option (i.e., user's urgency to reach a destination) before generating a final recommendation. In some embodiments, the commute options generation engine 250 may map or display the matched advertisements in all the identified routes using, for example, a navigation system screen or mapping application.

According to an embodiment, the commute options generation engine 250, using AI algorithms, identifies the route option that has the maximum number of advertisements pertaining to the top needs of the user and makes the route recommendation to the user via the user's device 260. In another embodiment, the commute options generation engine 250 sorts all possible commute options based on the relevance of the physical advertisements to match the user's needs and presents the sorted options to the user along with a rational. In an example, the commute options may be presented to the user using text or voice messages via user's device 260. The computer system 210 may store user actions (e.g., user used the recommended most relevant route, etc.) and explicit feedback from the user on the presented route recommendations in the knowledge corpus 270. Using the knowledge corpus 270, the computer system 210 may improve future recommendations based on the stored user actions and explicit feedback on the generated route options.

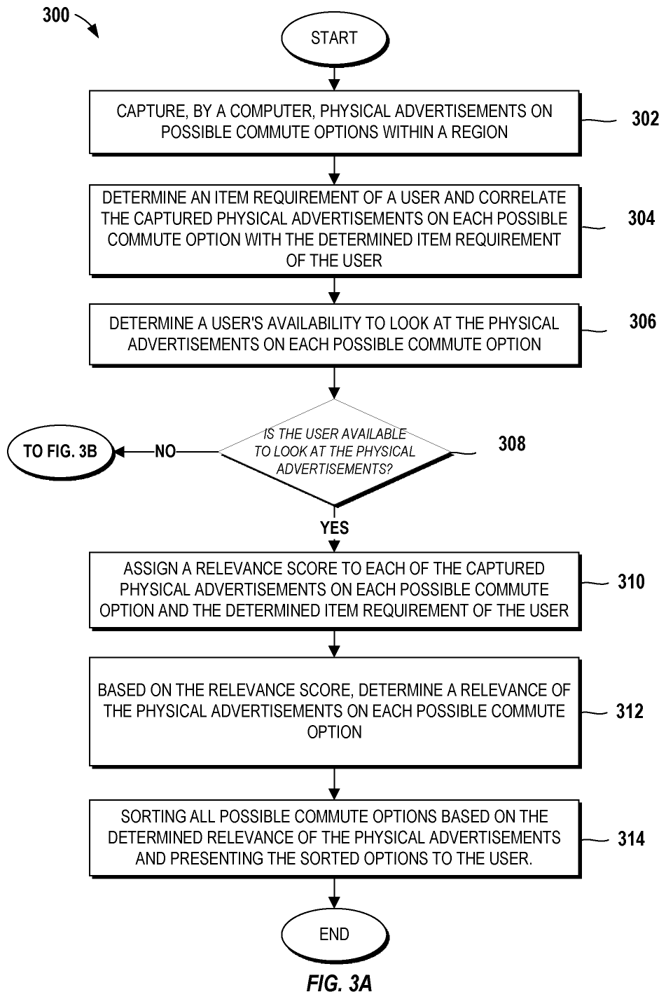

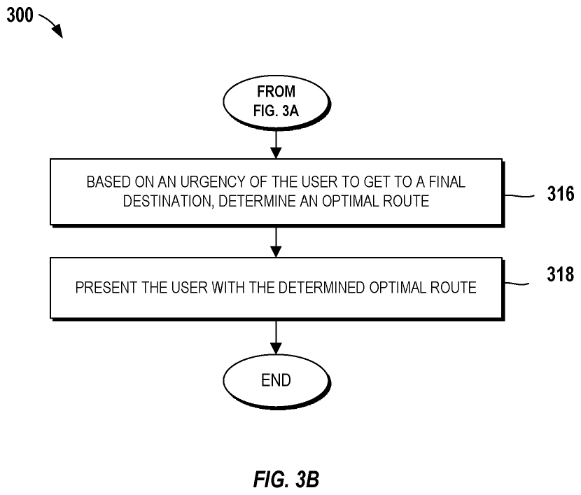

Referring now to FIGS. 3A-3B, a flowchart 300 illustrating the steps of a computer-implemented method for automatically recommending commute options to a user based on a relevance of physical advertisement on the commute options is shown, according to an embodiment of the present disclosure.

The process starts at step 303 in which a computer system, such as the computer system 210 described in FIG. 2, captures physical advertisements on possible commute options (e.g., public transportation including city buses and public railways, private vehicles including owned vehicles or a connection's vehicle, various transportation modes including train/metro or going by road, various routes including going from A to B via C and going from A to B via D, etc.) within a region (e.g., city, zone, etc.). In an exemplary embodiment, capturing of the physical advertisements is performed using IoT data (e.g., visual data received using cameras in trains, etc.), advertisement data (e.g., advertisement for all schools in the city, etc.), a map database (e.g., micro-location reporting advertisement position, etc.) and publicly available information (e.g., recent images available on the internet and social media sites).

At step 304, an item requirement of a user (i.e., a user of the computer system 210 shown in FIG. 2) is determined based on, for example, a purchase history of the user, a calendar or calendar entry, an interaction with customer service, messages and IoT data, an item type (e.g., product, service, etc.), and the like. Then, the determined captured physical advertisements (step 302) on each available commute option can be correlated, at step 304, with the determined item requirement of the user.

At step 306, the user's convenience or availability to look at the physical advertisements on each possible commute option between a starting point of a trip and a final point or destination of the trip can be determined using, for example, a calendar associated with the user, real-time IoT data from user's wearable devices, a destination, a search criteria for commute options, communication messages and a time predicted for the commute option.

At step 308, it is determined whether the user is available or has enough time to look at the physical advertisements, i.e., the user is not in a hurry to arrive to the final destination. If, at step 308, it is determined that the user is available to look at the physical advertisements, the process continues with step 310 by assigning a correlation or relevance score to each of the captured physical advertisement on each possible commute option and the determined item requirement of the user.

At step 312, based on the relevance score, a relevance of the physical advertisements on each possible commute option can be determined. Specifically, at step 312, the relevance score indicates a likelihood of the captured physical advertisement matching the determined user's item requirement.

At step 314, all available commute options are sorted based on the determined relevance of the physical advertisements (i.e., relevance score) and the determined user's availability to look at the physical advertisements. The sorted options can then be presented to the user along with a rational.

If, at step 308, it is determined that the user is not available to look at the physical advertisements, the process continues with step 316 (FIG. 3B) by determining an optimal route for the user to get to a final destination. The optimal route is determined based on an urgency of the user to get to the final destination, as explained above with reference to FIG. 2. At step 318, the optimal route is then presented to the user.

It should be noted that future commute options recommendations can be conducted based on user actions (e.g., user used the recommended most relevant route, etc.) and explicit feedback on the provided recommendations based on the relevance of the physical advertisements.

Thus, the previously described embodiments provide an AI-based system and method to automatically determining available physical advertisement on a region and correlating the available physical advertisement with an item requirement of the user, assigning a relevance score to each physical advertisement matching the item requirement of the user, sorting each possible commute option based on the relevance score and responsive to an availability of the user to look at the physical advertisement on each possible commute route, presenting the sorted possible commute options to the user via a user's device. Accordingly, the proposed embodiments can improve future commute option recommendations responsive to actions performed by the user and explicit user's feedback on the presented commute options based on the relevance of physical advertisement.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for recommending commute options based on advertisement relevance, comprising:
capturing, by one or more processors, physical advertisements on possible commute options within a region;
determining, by the one or more processors, an item requirement of a user and correlating the captured physical advertisements on each possible commute option with the determined item requirement of the user;
determining, by the one or more processors, a user's availability to look at the physical advertisements on each possible commute option between a starting point of a trip and a final point of the trip;
assigning, by the one or more processors, a relevance score to each of the captured physical advertisements on each possible commute option and the determined item requirement of the user; and
based on the relevance score and the determined user's availability to look at the physical advertisements for each possible commute option, sorting, by the one or more processors, all possible commute options and communicating the sorted commute options to a user device.

2. The method of claim 1, further comprising:
determining, by the one or more processors, the possible commute options between the starting point and the final point of the trip using variation thresholds on a traveling distance and a travel time.

3. The method of claim 1, further comprising:
improving, by the one or more processors, future commute option recommendations based on actions performed by the user and an explicit feedback from the user on the presented sorted options based on the relevance of the physical advertisements.

4. The method of claim 1, wherein the possible commute options comprise at least one of using public transportation including city buses and public railways; using a private vehicle including at least one of an owned vehicle and a connection's vehicle; using various transportation modes including a subway and a road; and using various routes including going from A to B via C and going from A to B via D.

5. The method of claim 1, wherein capturing the physical advertisements on the possible commute options is based on data collected from one or more of IoT devices available on the possible commute options including visual data, advertisement databases, map databases, and publicly available information including social media sites.

6. The method of claim 1, wherein determining the user's availability to look at the physical advertisements on each possible commute option is based on one or more of a user's calendar, real-time IoT data from wearable devices, a destination, a search criteria for commute options, communication messages and time predicted for the commute option.

7. The method of claim 1, wherein determining the item requirement of the user is based on one or more of a purchase history of the user, a calendar entry, an interaction with customer service, messages and IoT data, and wherein the item requirement comprises at least one of a product and a service.

8. A computer system for recommending commute options based on advertisement relevance, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
capturing, by the one or more processors, physical advertisements on possible commute options within a region;
determining, by the one or more processors, an item requirement of a user and correlating the captured physical advertisements on each possible commute option with the determined item requirement of the user;
determining, by the one or more processors, a user's availability to look at the physical advertisements on each possible commute option between a starting point of a trip and a final point of the trip;
assigning, by the one or more processors, a relevance score to each of the captured physical advertisements on each possible commute option and the determined item requirement of the user; and
based on the relevance score and the determined user's availability to look at the physical advertisements for each possible commute option, sorting, by the one or more processors, all possible commute options and communicating the sorted commute options to a user device.

9. The computer system of claim 8, further comprising:
determining, by the one or more processors, the possible commute options between the starting point and the final point of the trip using variation thresholds on a traveling distance and a travel time.

10. The computer system of claim 8, further comprising:
improving, by the one or more processors, future commute option recommendations based on actions performed by the user and an explicit feedback from the user on the presented sorted options based on the relevance of the physical advertisements.

11. The computer system of claim 8, wherein the possible commute options comprise at least one of using public transportation including city buses and public railways; using a private vehicle including at least one of an owned vehicle and a connection's vehicle; using various transportation modes including a subway and a road; and using various routes including going from A to B via C and going from A to B via D.

12. The computer system of claim 8, wherein capturing the physical advertisements on the possible commute options is based on data collected from one or more of IoT devices available on the possible commute options including visual data, advertisement databases, map databases, and publicly available information including social media sites.

13. The computer system of claim 8, wherein determining the user's availability to look at the physical advertisements on each possible commute option is based on one or more of a user's calendar, real-time IoT data from wearable devices, a destination, a search criteria for commute options, communication messages and time predicted for the commute option.

14. The computer system of claim 8, wherein determining the item requirement of the user is based on one or more of a purchase history of the user, a calendar entry, an interaction with customer service, messages and IoT data, and wherein the item requirement comprises at least one of a product and a service.

15. A computer program product for recommending commute options based on advertisement relevance, comprising:
one or more computer readable storage media, and program instructions collectively stored on the one or more computer readable storage media, the program instructions comprising:
program instructions to capture, by one or more processors, physical advertisements on possible commute options within a region;
program instructions to determine, by the one or more processors, an item requirement of a user and correlating the captured physical advertisements on each possible commute option with the determined item requirement of the user;
program instructions to determine, by the one or more processors, a user's availability to look at the physical advertisements on each possible commute option between a starting point of a trip and a final point of the trip;
program instructions to assign, by the one or more processors, a relevance score to each of the captured physical advertisements on each possible commute option and the determined item requirement of the user; and
based on the relevance score and the determined user's availability to look at the physical advertisements for each possible commute option, program instructions to sort, by the one or more processors, all possible commute options and communicate the sorted commute options to a user device.

16. The computer program product of claim 15, further comprising:
program instructions to determine, by the one or more processors, the possible commute options between the starting point and the final point of the trip using variation thresholds on a traveling distance and a travel time.

17. The computer program product of claim 15, further comprising:
program instructions to improve, by the one or more processors, future commute option recommendations based on actions performed by the user and an explicit feedback from the user on the presented sorted options based on the relevance of the physical advertisements.

18. The computer program product of claim 15, wherein the possible commute options comprise at least one of using public transportation including city buses and public railways; using a private vehicle including at least one of an owned vehicle and a connection's vehicle; using various transportation modes including a subway and a road; and using various routes including going from A to B via C and going from A to B via D.

19. The computer program product of claim 15, wherein the program instructions to capture the physical advertisements on the possible commute options are based on data collected from one or more of IoT devices available on the possible commute options including visual data, advertisement databases, map databases, and publicly available information including social media sites.

20. The computer program product of claim 15, wherein the program instructions to determine the user's availability to look at the physical advertisements on each possible commute option are based on one or more of a user's calendar, real-time IoT data from wearable devices, a destination, a search criteria for commute options, communication messages and time predicted for the commute option, and wherein the program instructions to determine the item requirement of the user is based on one or more of a purchase history of the user, a calendar entry, an interaction with customer service, messages and IoT data, and wherein the item requirement comprises at least one of a product and a service.
